(19) United States
(12) Patent Application Publication
(10) Pub. No.: US 2017/0277048 A1
(43) Pub. Date: Sep. 28, 2017

(54) ELECTROPHOTOGRAPHIC PHOTORECEPTOR, PROCESS CARTRIDGE, AND IMAGE FORMING APPARATUS

(71) Applicant: FUJI XEROX CO., LTD., Tokyo (JP)

(72) Inventors: Kota MAKI, Kanagawa (JP); Shigeto HASHIBA, Kanagawa (JP)

(73) Assignee: FUJI XEROX CO., LTD., Tokyo (JP)

(21) Appl. No.: 15/244,222

(22) Filed: Aug. 23, 2016

(30) Foreign Application Priority Data
Mar. 28, 2016 (JP) 2016-064675

(51) Int. Cl. G03G 15/00

(52) U.S. Cl. CPC G03G 5/047; G03G 21/18

(57) ABSTRACT

An electrophotographic photoreceptor includes a charge generation layer including a charge generating material and a hindered phenol antioxidant, and a charge transport layer including a charge transport material represented by formula (CT1) and a charge transport material represented by formula (CT2):

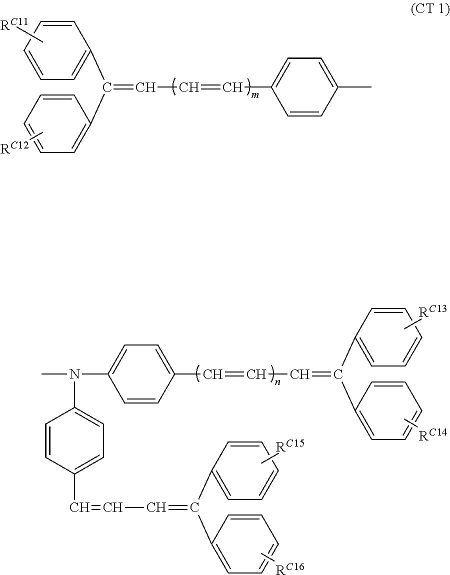

wherein R^{C11}, R^{C12}, R^{C13}, R^{C14}, R^{C15} and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and n and m each independently represent 0, 1, or 2; and

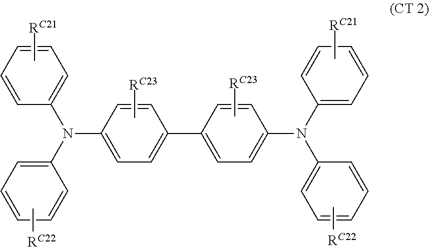

wherein R^{C21}, R^{C22} , and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

### CROSS-REFERENCE TO RELATED APPLICATIONS

This application is based on and claims priority under 35 USC 119 from Japanese Patent Application No. 2016-064675 filed Mar. 28, 2016.

### BACKGROUND

1. Technical Field

The present invention relates to an electrophotographic photoreceptor, a process cartridge, and an image forming apparatus.

2. Related Art

In the related art, an apparatus for sequentially performing charging, forming an electrostatic latent image, developing, transferring, cleaning, and the like using an electrophotographic photoreceptor (hereinafter referred to as a “photoreceptor” in some cases) is widely known as an electrophotographic image forming apparatus.

As the electrophotographic photoreceptor, a function-separation type photoreceptor in which a charge generation layer that generates charges and a charge transport layer that transports charges are laminated on an electroconductive substrate such as aluminum is known, in addition to a single-layer photoreceptor in which a function of generating charges and a function of transporting charges are integrated in the same layer.

### SUMMARY

According to an aspect of the invention, there is provided an electrophotographic photoreceptor including:

an electroconductive substrate;

a charge generation layer that is provided on the electroconductive substrate and includes a charge generating material and a hindered phenol antioxidant; and

a charge transport layer that is provided on the charge generation layer and includes a charge transport material represented by the following formula (CT1) and a charge transport material represented by the following formula (CT2):

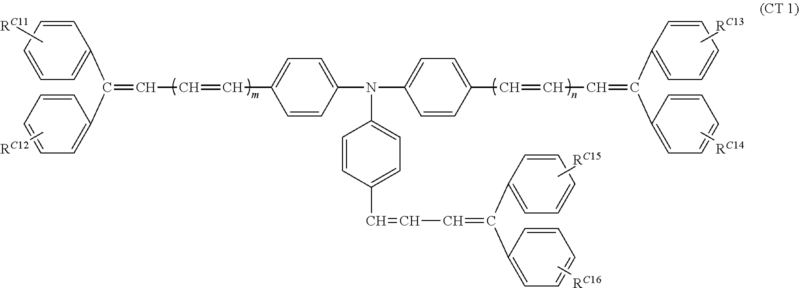

wherein R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, two adjacent substituents may be bonded to each other to form a hydrocarbon ring structure, and n and m each independently represent 0, 1, or 2; and

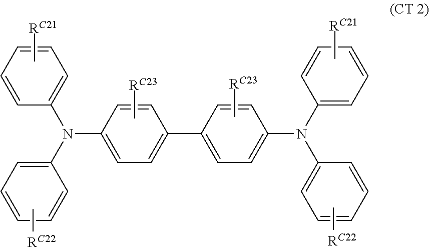

wherein R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

### BRIEF DESCRIPTION OF THE DRAWINGS

Exemplary embodiments of the present invention will be described in detail based on the following figures, wherein:

FIG. 1 is a schematic partial cross-sectional diagram showing one example of the layer configuration of the electrophotographic photoreceptor according to the exemplary embodiment;

FIG. 2 is a schematic configuration diagram showing one example of the image forming apparatus according to the exemplary embodiment; and

FIG. 3 is a schematic configuration diagram showing another example of the image forming apparatus according to the exemplary embodiment.

### DETAILED DESCRIPTION

Hereinbelow, an exemplary embodiment that is one example of the invention will be described with reference to the drawings.

### Electrophotographic Photoreceptor

The electrophotographic photoreceptor according to the exemplary embodiment (hereinafter referred to as a “photoreceptor” in some cases) has an electroconductive substrate, a charge generation layer that is provided on the electroconductive substrate and includes a charge generating material and a hindered phenol antioxidant, and a charge transport layer that is provided on the charge generation layer and includes a charge transport material represented by the following formula (CT1) (hereinafter also referred to as a “butadiene charge transport material (CT1)”) and a charge transport material represented by the following formula (CT2) (hereinafter also referred to as a “benzidine charge transport material (CT2)”).

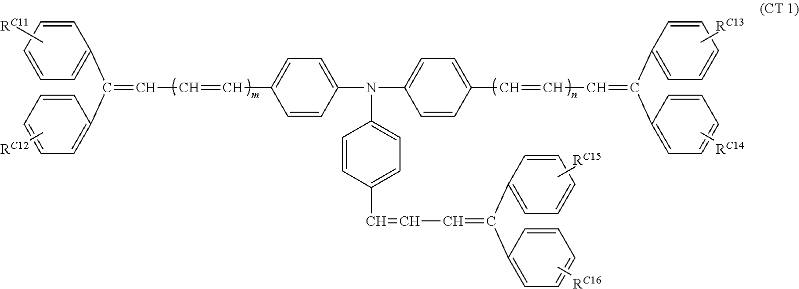

In formula (CT1) , R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and two adjacent substituents may be bonded to each other to form a hydrocarbon ring structure. n and m each independently represent 0, 1, or 2.

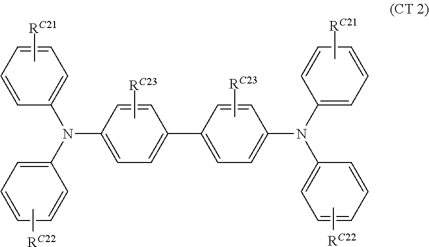

In formula (CT2) , R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

By applying the photoreceptor according to the exemplary embodiment as an image holding member in an image forming apparatus, occurrence of burn-in ghosting upon continuous output of the same images is prevented. The reason therefor is presumed as follows.

The butadiene charge transport material (CT1) has high charge mobility, and is thus suitable for obtaining a charge transport layer having high charge transportability. On the other hand, the butadiene charge transport material (CT1) has low solubility properties in a solvent. Thus, in order to obtain a charge transport layer having high charge transportability, it is preferable to use the butadiene charge transport material (CT1) in combination with the benzidine charge transport material (CT2) having a relatively high charge mobility and a high solubility in a solvent.

However, when the same images are continuously output (for example, continuously output on 3,000 sheets), and then, for example, a full half-tone image is output by using an image forming apparatus including a photoreceptor having a charge transport layer including both of the butadiene charge transport material (CT1) and the benzidine charge transport material (CT2), burn-in ghosting (positive ghosting) in which the surface potential of the photoreceptor in the continuously exposed area decreases by output of the same images, and thus the density becomes higher occurs in some cases.

The reason why such the burn-in ghosting (positive ghosting) occurs is considered to be as follows. For example, in the case of an image forming mode using reversal development by negatively charging an electrophotographic photoreceptor, a part of holes produced by image exposure is accumulated within the charge generation layer and in the vicinity of the interface between the charge generation layer and the charge transport layer, and moved onto the surface of the charge transport layer immediately after the charging step in the next cycle, the surface potential decreases, thereby causing burn-in ghosting (positive ghosting) in which the image in the former cycle becomes darker.

Furthermore, the increase in the density of the image due to a decrease in the surface potential is particularly notable in the case where the charge transport layer contains both of the butadiene charge transport material (CT1) and the benzidine charge transport material (CT2). This is considered to be due to a fact that since the butadiene charge transport material (CT1) has high charge transportability in terms of its structure, the unlocalized region of electrons within the molecule is large, an interaction between the benzidine charge transport material (CT2) and the charge generating material is generated, and thus, a decrease in the charging potential is remarkably generated due to the continuous output of the same image.

In contrast, it is considered that if the photoreceptor has a charge transport layer including both of the butadiene charge transport material (CT1) and the benzidine charge transport material (CT2); and a charge generation layer including a charge generating material and a hindered phenol antioxidant are included, the difference in the energy level between the charge generation layer and the charge transport layer becomes small and the transportability is enhanced, and thus, occurrence of burn-in ghosting is prevented.

Moreover, it is considered that in the case where a hydroxygallium phthalocyanine pigment having a high charge generating efficiency as a charge generating material is included in the charge generation layer, the amount of generated charges is high, and therefore, the decrease in the charging potential due to the continuous output of the same images and occurrence of light fatigue upon optical exposure becomes remarkable, burn-in ghosting easily occurs. However, in the electrophotographic photoreceptor according to the exemplary embodiment, even in the case where hydroxygallium phthalocyanine is included in the charge generation layer, occurrence of burn-in ghosting upon continuous output of the same images is prevented.

Furthermore, upon replacement of a photoreceptor, or the like, if the photoreceptor is optically exposed to room light, sunlight, or the like, the chargeability of the photoreceptor at the optically exposed areas decreases, and thereafter, if the full half-tone image is output, an image defect called “light fatigue” in that the image density of the optically exposed areas becomes dark occurs in some cases. According to the photoreceptor of the exemplary embodiment, occurrence of light fatigue due to the above-described optical exposure is also prevented, as compared with a case of using a hindered amine antioxidant alone as an antioxidant in the charge generation layer.

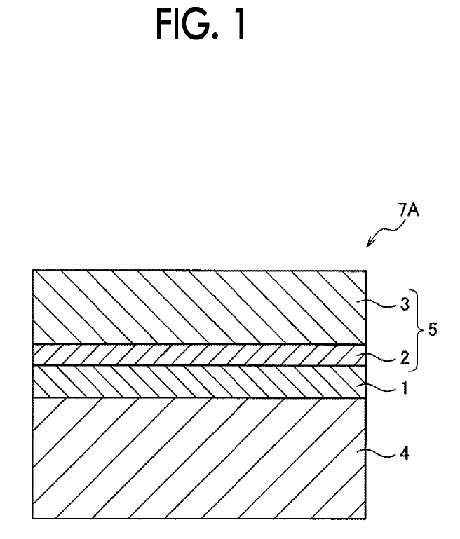

FIG. 1 is a schematic partial cross-sectional diagram showing one example of the layer configuration of the electrophotographic photoreceptor 7A according to the exemplary embodiment. The electrophotographic photoreceptor 7A shown in FIG. 1 has a structure in which an undercoat layer 1, a charge generation layer 2, and a charge transport layer 3 are laminated in this order on an electroconductive substrate 4. Further, the charge generation layer 2 and the charge transport layer 3 constitutes a photosensitive layer 5.

Furthermore, the electrophotographic photoreceptor 7A may have a layer configuration in which the undercoat layer is not provided. Further, the electrophotographic photoreceptor 7A may have a layer configuration in which a protective layer is additionally provided on the charge transport layer 3.

Each of the layers of the electrophotographic photoreceptor according to the exemplary embodiment will be described in detail. Further, the symbols are omitted for description.

### Conductive Substrate

Examples of the electroconductive substrate include metal plates, metal drums, and metal belts containing metals (aluminum, copper, zinc, chromium, nickel, molybdenum, vanadium, indium, gold, platinum, and the like) or alloys (stainless steel and the like). Other examples of the electroconductive substrate include paper, resin films, and belts, each formed by applying, depositing, or laminating conductive compounds (for example, a conductive polymer and indium oxide), metals (for example, aluminum, palladium, and gold), or alloys. The term “being conductive” herein refers to having a volume resistivity of less than 10¹³ Ωcm.

In the case where the electrophotographic photoreceptor is used in a laser printer, the surface of the electroconductive substrate is preferably roughened at a center-line average roughness, Ra, which is from 0.04 μm to 0.5 μm in order to prevent an interference fringe generated upon radiation with laser light. In the case where an incoherent light source is used, there is no particular need for the surface of the electroconductive substrate to be roughened so as to prevent an interference fringe, and such an incoherent light source may prevent occurrence of defects due to uneven surface of the electroconductive substrate, and is therefore more suitable for prolonging the lifetime.

Examples of a surface roughening method include wet honing in which an abrasive suspended in water is sprayed to a support, centerless grinding in which continuous grinding is carried out by pressing the electroconductive substrate against a rotating grindstone, and an anodization treatment.

Other examples of the surface roughening method include a method in which while not roughening the surface of the electroconductive substrate, conductive or semiconductive powder is dispersed in a resin, the resin is applied onto the surface of the electroconductive substrate to form a layer, and roughening is carried out by the particles dispersed in the layer.

In the surface roughening treatment by anodization, an electroconductive substrate formed of a metal (for example, aluminum) serves as the anode in an electrolyte solution and is anodized to form an oxide film on the surface of the electroconductive substrate. Examples of the electrolyte solution include a sulfuric acid solution and an oxalic acid solution. A porous anodized film formed by anodizing is, however, chemically active in its natural state, and thus, such an anodized film is easily contaminated, and its resistance greatly varies depending on environment. Accordingly, a treatment for closing the pores of the porous anodized film is preferably carried out; in such a process, the pores of the oxidized film are closed by volume expansion due to a hydration reaction in steam under pressure or in boiled water (a metal salt such as nickel may be added), and the porous anodized film is converted into more stable hydrous oxide.

The film thickness of the anodized film is preferably, for example, from 0.3 μm to 15 μm. If the film thickness is within this range, a barrier property for implantation tends to be exerted and an increase in residual potential due to repeated uses tends to be prevented.

The electroconductive substrate may be subjected to a treatment with an acidic treatment solution or a boehmite treatment.

The treatment with an acidic treatment solution is carried out, for example, as follows. An acidic treatment solution containing phosphoric acid, chromic acid, and hydrofluoric acid is prepared. For the blend ratio of the phosphoric acid, the chromic acid, and the hydrofluoric acid in the acidic treatment solution, for example, the amount of the phosphoric acid is in the range from 10% by weight to 11% by weight, the amount of the chromic acid is in the range from 3% by weight to 5% by weight, and the amount of the hydrofluoric acid is in the range from 0.5% by weight to 2% by weight, and the total concentration of these acids is preferably in the range from 13.5% by weight to 18% by weight. The temperature for the treatment is preferably, for example, from 42° C. to 48° C. The film thickness of the coating film is preferably from 0.3 μm to 15 μm.

In the boehmite treatment, for example, the electroconductive substrate is immersed into pure water at a temperature from 90° C. to 100° C. from 5 minutes to 60 minutes or brought into contact with heated water vapor at a temperature from 90° C. to 120° C. from 5 minutes to 60 minutes. The film thickness of the coating film is preferably from 0.1 μm to 5 μm. The obtained product may be subjected to an anodization treatment with an electrolyte solution which less dissolves the coating film, such as adipic acid, boric acid, borate, phosphate, phthalate, maleate, benzoate, tartrate, and citrate.

Undercoat Layer

The undercoat layer is a layer including, for example, inorganic particles and a binder resin.

Examples of the inorganic particles include inorganic particles having a powder resistivity (volume resistivity) that is from 10² Ωcm to 10¹¹ Ωcm.

Among these, as the inorganic particles having such a resistance value, metal oxide particles such as tin oxide particles, titanium oxide particles, zinc oxide particles, and zirconium oxide particles are preferable, and zinc oxide particles are particularly preferable.

The specific surface area of the inorganic particles in accordance with a BET method is preferably, for example, equal to or more than 10 m²/g.

The volume average particle diameter of the inorganic particles is preferably, for example, from 50 nm to 2,000 nm (particularly from 60 nm to 1,000 nm).

The content of the inorganic particles is preferably, for example, from 10% by weight to 80% by weight, and more preferably from 40% by weight to 80% by weight, with respect to the binder resin.

The inorganic particles may have been subjected to a surface treatment. Two or more kinds of inorganic particles which have been subjected to different surface treatments or which have different particle diameters may be used as a mixture.

Examples of the surface treating agent include a silane coupling agent, a titanate coupling agent, an aluminum coupling agent, and a surfactant. In particular, a silane coupling agent is preferable, and a silane coupling agent having an amino group is more preferable.

Examples of the silane coupling agent having an amino group include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis (2-hydroxyethyl)-3-aminopropyltriethoxysilane.

Two or more kinds of silane coupling agents may be used as a mixture. For example, the silane coupling agent having an amino group may be used in combination with another silane coupling agent. Examples of such another silane coupling agent include, but are not limited to, vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method using a surface treating agent may be carried out by any known technique, and either a dry process or a wet process may be employed.

The amount of the surface treating agent used for the treatment is preferably, for example, from 0.5% by weight to 10% by weight with respect to the inorganic particles.

Here, it is preferable that the undercoat layer contains an electron accepting compound (acceptor compound) in addition to the inorganic particles from the viewpoints of the long-term stability of electrical properties and an increase in carrier blocking properties.

Examples of the electron accepting compound include electron transporting materials, including, for example, quinone compounds such as chloranil and bromanil; tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; and diphenoquinone compounds such as 3,3′,5,5′-tetra-t-butyldiphenoquinone.

In particular, compounds having an anthraquinone structure are preferable as the electron accepting compound. As the compounds having an anthraquinone structure, for example, a hydroxyanthraquinone compound, an aminoanthraquinone compound, and an aminohydroxyanthraquinone compound are preferable, and specifically, for example, anthraquinone, alizarin, quinizarin, anthrarufin, and purpurin are preferable.

The electron accepting compound may be included in the undercoat layer in a state of being dispersed together with the inorganic particles in the undercoat layer, or may be included in a state of adhering to the surfaces of the inorganic particles.

Examples of a method for allowing the electron accepting compound to adhere to the surfaces of the inorganic particles include a dry process and a wet process.

The dry process is, for example, a method in which an electron accepting compound is allowed to adhere to the surfaces of the inorganic particles as follows: inorganic particles are stirred in a mixer with a high shear force, and in this state, the electron accepting compound as it is or as a solution in which the electron accepting compound dissolved in an organic solvent is dropped or sprayed along with dried air or a nitrogen gas. The electron accepting compound may be dropped or sprayed at a temperature that is equal to or lower than the boiling point of the solvent. After dropping or spraying the electron accepting compound, baking may be carried out at equal to or higher than 100° C. Baking may be carried out at any temperature for any length of time provided that electrophotographic properties are obtained.

The wet process is, for example, a method in which the electron accepting compound is allowed to adhere to the surfaces of the inorganic particles as follows: the inorganic particles are dispersed in a solvent by a technique involving stirring, ultrasonic wave, a sand mill, an attritor, or a ball mill, in this state, the electron accepting compound is added thereto and then stirred or dispersed, and the solvent is subsequently removed. The solvent is removed, for example, through filtration or distillation. After the removal of the solvent, baking may be carried out at equal to or higher than 100° C. Baking may be carried out at any temperature for any length of time provided that electrophotographic properties are obtained. In the wet process, the moisture content in the inorganic particles may be removed in advance of the addition of the electron accepting compound, and examples of the wet process include a method in which a moisture content is removed by stirring in a solvent under heating or a method in which a moisture content is removed by azeotropy with a solvent.

Moreover, the electron accepting compound may be allowed to adhere before or after the surface treatment of the inorganic particles with a surface treating agent, and the adhesion of the electron accepting compound and the surface treatment with the surface treating agent may be simultaneously carried out.

The content of the electron accepting compound is, for example, preferably from 0.01% by weight to 20% by weight, and more preferably from 0.01% by weight to 10% by weight, with respect to the inorganic particles.

Examples of the binder resin for use in the undercoat layer include known high molecular compounds such as acetal resins (for example, polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and known materials such as silane coupling agents.

Other examples of the binder resin for use in the undercoat layer include electron transporting resins having electron transporting groups and conductive resins (for example, polyaniline).

Among these, a resin that is insoluble in a solvent used in a coating liquid for forming the upper layer is suitable as the binder resin for use in the undercoat layer. In particular, resins obtained by a reaction of a curing agent with at least one resin selected from the group consisting of thermosetting resins such as urea resins, phenolic resins, phenol-formaldehyde resins, melamine resins, urethane resins, unsaturated polyester resins, alkyd resins, and epoxy resins; polyamide resins; polyester resins; polyether resins; methacrylic resins; acrylic resins; polyvinyl alcohol resins; and polyvinyl acetal resins are suitable.

In the case where two or more kinds of these binder resins are used in combination, the mixing ratio thereof is determined, as desired.

The undercoat layer may include a variety of additives in order to improve electrical properties, environmental stability, and image quality.

Examples of the additives include electron transporting pigments such as condensed polycyclic pigments and azo pigments, and known materials such as zirconium chelate compounds, titanium chelate compounds, aluminum chelate compounds, titanium alkoxide compounds, organic titanium compounds, and silane coupling agents. A silane coupling agent is used for the surface treatment of the inorganic particles as described above and may be further added as an additive to the undercoat layer.

Examples of the silane coupling agent as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethylmethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetra-n-butyl titanate, butyl titanate dimers, tetra(2-ethylhexyl)titanate, titanium acetylacetonate, polytitanium acetylacetonate, titanium octylene glycolate, titanium lactate ammonium salts, titanium lactate, titanium lactate ethyl esters, titanium triethanol aminate, and polyhydroxytitanium stearate.

Examples of the aluminum chelate compounds include aluminum isopropylate, monobutoxyaluminum diisopropylate, aluminum butylate, diethyl acetoacetate aluminum diisopropylate, and aluminum tris(ethyl acetoacetate).

These additives may be used alone or as a mixture or a polycondensate of plural kinds thereof.

The undercoat layer is preferably one having a Vickers hardness of equal to or more than 35.

In order to prevent a moire fringe, the surface roughness (ten-point average roughness) of the undercoat layer is preferably adjusted to a range from 1/(4n) (n is the refractive index of the upper layer) to 1/2 of the laser wavelength λ for exposure to be used.

In order to adjust the surface roughness, resin particles or the like may be added to the undercoat layer. Examples of the resin particles include silicone resin particles and crosslinked polymethyl methacrylate resin particles. In addition, the surface of the undercoat layer may be polished to adjust the surface roughness. Examples of a polishing method include buffing polishing, sand blasting treatment, wet honing, and grinding treatment.

A technique for forming the undercoat layer is not particularly limited, and any known technique is used. For example, formation of the undercoat layer is carried out by forming a coating film of a coating liquid for forming an undercoat layer, prepared by adding the components to a solvent, and then drying the coating film, followed by heating, as desired.

Examples of the solvent for use in the preparation of the coating liquid for forming an undercoat layer include known organic solvents such as an alcohol solvent, an aromatic hydrocarbon solvent, a halogenated hydrocarbon solvent, a ketone solvent, a ketone alcohol solvent, an ether solvent, and an ester solvent.

Specific examples of these solvents include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of a method for dispersing the inorganic particles in the preparation of the coating liquid for forming an undercoat layer include known methods using a roller mill, a ball mill, a vibratory ball mill, an attritor, a sand mill, a colloid mill, a paint shaker, or the like.

Examples of a method for applying the coating liquid for forming an undercoat layer onto the electroconductive substrate include common methods such as a blade coating method, a wire-bar coating method, a spray coating method, a dipping coating method, a bead coating method, an air knife coating method, and a curtain coating method.

The film thickness of the undercoat layer is set to be, for example, preferably in the range of equal to or more than 15 μm, and more preferably in the range from 20 μm to 50 μm.

### Intermediate Layer

Although not shown in the drawings, an interlayer may further be provided between the undercoat layer and the photosensitive layer.

The intermediate layer is, for example, a layer including a resin. Examples of the resin for use in the intermediate layer include polymeric compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may be a layer that contains an organic metal compound. Examples of the organic metal compound for use in the intermediate layer include those that contain metal atoms such as zirconium, titanium, aluminum, manganese, and silicon.

These compounds for use in the intermediate layer may be used alone or as a mixture or a polycondensate of plural kinds of the compounds.

Among these, the intermediate layer is preferably a layer that includes an organic metal compound containing a zirconium atom or a silicon atom.

A technique for forming the intermediate layer is not particularly limited, and known methods are used. For example, formation of a coating film is carried out by forming a coating film of a coating liquid for forming an intermediate layer, prepared by adding the components to a solvent, drying the coating film, followed by heating, as desired.

As a coating method used for forming the intermediate layer, common methods such as a dipping coating method, an extrusion coating method, a wire bar coating method, a spray coating method, a blade coating method, a knife coating method, and a curtain coating method are used.

The film thickness of the intermediate layer is preferably set to be, for example, in the range from 0.1 μm to 3 μm. In addition, the intermediate layer may be used as an undercoat layer.

### Charge Generation Layer

The charge generation layer is a layer including, for example, a charge generating material, a hindered phenol antioxidant, and a binder resin. Further, the charge generation layer may be a vapor-deposited layer of a charge generating material. The vapor-deposited layer of a charge generating material is suitable in the case where an incoherent light source such as a Light Emitting Diode (LED) or an Organic Electro-Luminescence (EL) image array is used.

Examples of the charge generating material include azo pigments such as bisazo and trisazo pigments, fused aromatic pigments such as dibromoanthanthrone; perylene pigments; pyrrolopyrrole pigments; phthalocyanine pigments; zinc oxide; and trigonal selenium.

Among these, a metal phthalocyanine pigment or a metal-free phthalocyanine pigment is preferably used as a charge generating material in order to be compatible with laser exposure in a near-infrared region. Specifically, for example, hydroxygallium phthalocyanine, chlorogallium phthalocyanine, dichlorotin phthalocyanine, and titanyl phthalocyanine are more preferable.

On the other hand, in order to be compatible with laser exposure in a near-ultraviolet region, fused aromatic pigments such as dibromoanthanthrone; thioindigo pigments; porphyrazine compounds; zinc oxide; trigonal selenium, bisazo pigments are preferable as a charge generating material.

The charge generating materials may be used even in the case where an incoherent light source such as an organic EL image array or an LED having a center wavelength for light emission within the range from 450 nm to 780 nm is used. However, when the photosensitive layer is designed as a thin film having a thickness of equal to or less than 20 μm from the viewpoint of resolution, the electric field strength in the photosensitive layer increases and electrification obtained from charge injection from the electroconductive substrate decreases, thereby readily generating image defects referred to a so-called black spot. This phenomenon becomes notable when a charge generating material, such as trigonal selenium or a phthalocyanine pigment, that readily generates dark current in a p-type semiconductor is used.

In contrast, when a n-type semiconductor such as a fused aromatic pigment, a perylene pigment, and an azo pigment is used as the charge generating material, dark current rarely occurs and image defects referred to black spot are prevented even in the case where the photoconductive layer is in the form of a thin film. Examples of the n-type charge generating material include, but are not limited to, the compounds (CG-1) to (CG-27) described in paragraphs [0288] to [0291] of JP-A-2012-155282.

Furthermore, whether the material is of a n-type is determined by the polarity of the photocurrent that flows in a commonly used time-of-flight method and the material in which electrons rather than holes easily flow as a carrier is identified as the n-type.

Among these, as the charge generating material, a hydroxygallium phthalocyanine pigment is preferable, and a V type hydroxygallium phthalocyanine pigment is more preferable, from the viewpoint of charge generating efficiency.

In particular, a hydroxygallium phthalocyanine pigment having a maximum peak wavelength within a range from 810 nm to 839 nm in a spectral spectrum in a wavelength region of from 600 nm to 900 nm, for example, is preferable as the a hydroxygallium phthalocyanine pigment, from the viewpoint of obtaining more excellent dispersibility.

In addition, the hydroxygallium phthalocyanine pigment having a maximum peak wavelength within a range from 810 nm to 839 nm preferably has an average particle diameter within a specific range and has a BET specific surface area within a specific range. Specifically, the average particle diameter is preferably equal to or less than 0.20 μm, and more preferably from 0.01 μm to 0.15 μm. The BET specific surface area is preferably equal to or more than 45 m²/g, more preferably equal to or more than 50 m²/g, and particularly preferably from 55 m²/g to 120 m²/g. The average particle is a volume average particle diameter (d50 average particle diameter) measured using a laser diffraction/scattering particle diameter distribution measuring device (LA-700 manufactured by HORIBA, Ltd.). In addition, the BET specific surface area is a value measured by a nitrogen substitution method using a BET specific surface area measuring instrument (FLOWSORB II 2300 manufactured by Shimadzu Corporation).

The maximum particle diameter (the maximum value of the primary particle diameters) of the hydroxygallium phthalocyanine pigment is preferably equal to or less than 1.2 μm, more preferably equal to or less than 1.0 μm, and still more preferably equal to or less than 0.3 μm.

Moreover, the hydroxygallium phthalocyanine pigment preferably has an average particle size of equal to or less than 0.2 μm, a maximum particle diameter of equal to or less than 1.2 μm, and a specific surface area value of equal to or more 45 m²/g.

The hydroxygallium phthalocyanine pigment is preferably a V type one having diffraction peaks at Bragg angles (2θ±0.2°) of 7.3°, 16.0°, 24.9°, and 28.0° in the X-ray diffraction spectrum using CuKα characteristic X-rays.

The charge generating material may be used alone or in combination of two or more kinds thereof.

The hindered phenol antioxidant will be described.

The hindered phenol antioxidant is a compound having a hindered phenol ring and preferably has a molecular weight of 300 or more.

In the hindered phenol antioxidant, the hindered phenol ring is, for example, a phenol ring having at least one of alkyl groups having from 4 to 8 carbon atoms (for example, branched alkyl groups having from 4 to 8 carbon atoms) substituted therein. More specifically, the hindered phenol ring is, for example, a phenol ring in which an ortho position with respect to the phenolic hydroxyl group is substituted with a tertiary alkyl group (for example, a tert-butyl group).

Examples of the hindered phenol antioxidant include:

1) an antioxidant having one hindered phenol ring,

2) an antioxidant having from 2 to 4 hindered phenol rings, in which a linking group formed of linear or branched bi- to tetravalent aliphatic hydrocarbon groups, or a linking group having at least one of an ester bond (—C(═O)O—) and an ether bond (—O—) interposed between carbon-carbon bonds of the bi- to tetravalent aliphatic hydrocarbon groups is linked to the from 2 to 4 hindered phenol rings, and

3) an antioxidant having 2 to 4 hindered phenol rings and one benzene ring (an unsubstituted benzene ring or a substituted benzene ring having an alkyl group or the like substituted therein) or an isocyanurate ring, in which the 2 to 4 hindered phenol rings are each linked to the benzene ring or the isocyanurate ring via an alkylene group.

An antioxidant represented by the following formula (HP) is preferable as the hindered phenol antioxidant from the viewpoint of prevention of burn-in ghosting and light fatigue.

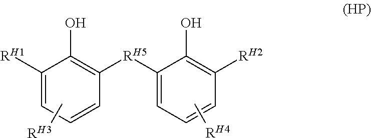

In formula (HP), R^{H1} and R^{H2} each independently represent a branched alkyl group having from 4 to 8 carbon atoms.

R^{H3} and R^{H4} each independently represent a hydrogen atom or an alkyl group having from 1 to 10 carbon atoms.

R^{H5} represents an alkylene group having from 1 to 10 carbon atoms.

In formula (HP), examples of the alkyl groups represented by R^{H1} and R^{H2} include a branched alkyl group having from 4 to 8 carbon atoms (preferably having from 4 to 6 carbon atoms).

Specific examples of the branched alkyl group include an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, and a tert-octyl group.

Among these, a tert-butyl group and a tert-pentyl group are preferable, and a tert-butyl group is more preferable as the alkyl group.

In formula (HP), examples of R^{H3} and R^{H4} include a linear or branched alkyl group having from 1 to 10 carbon atoms (preferably having from 1 to 4 carbon atoms).

Specific examples of the linear alkyl group include a methyl group, an ethyl group, a n-propyl group, a n-butyl group, a n-pentyl group, a n-hexyl group, a n-heptyl group, a n-octyl group, a n-nonyl group, and a n-decyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among these, lower alkyl groups such as a methyl group and an ethyl group are preferable as the alkyl group.

In formula (HP), R^{H5} represents a linear or branched alkylene group having from 1 to 10 carbon atoms (preferably having from 1 to 4 carbon atoms).

Specific examples of the linear alkylene group include a methylene group, an ethylene group, a n-propylene group, a n-butylene group, a n-pentylene group, a n-hexylene group, a n-heptylene group, a n-octylene group, a n-nonylene group, and a n-decylene group.

Specific examples of the branched alkylene group include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, and a tert-decylene group.

Among these, lower alkylene groups such as a methylene group, an ethylene group, and a butylene group are preferable as the alkylene group.

Furthermore, in formula (HP), examples of the respective substituents represented by R^{H1}, R^{H2}, R^{H3}, R^{H4}, and R^{H5} include groups further having substituents. Examples of the substituent include halogen atoms (for example, a fluorine atom and a chlorine atom), alkoxy groups (for example, an alkoxy group having from 1 to 4 carbon atoms), and aryl groups (for example, a phenyl group and a naphthyl group).

In formula (HP), particularly from the viewpoint of prevention of burn-in ghosting and light fatigue, it is preferable that R^{H1} and R^{H2} represent a tert-butyl group, and it is more preferable that R^{H1} and R^{H2} represent a tert-butyl group, R^{H3} and R^{H4} represent an alkyl group having from 1 to 3 carbon atoms (particularly a methyl group), and R^{H5} represents an alkylene group having from 1 to 4 carbon atoms (particularly a methylene group).

Specifically, it is particularly preferable that the hindered phenol antioxidant is a hindered phenol antioxidant represented by an exemplary compound (HP-3).

The molecular weight of the hindered phenol antioxidant is preferably from 300 to 1,000, more preferably from 300 to 900, and still more preferably from 300 to 800, from the viewpoint of prevention of burn-in ghosting and light fatigue.

Specific examples of the hindered phenol antioxidant are shown below, but are not limited thereto.

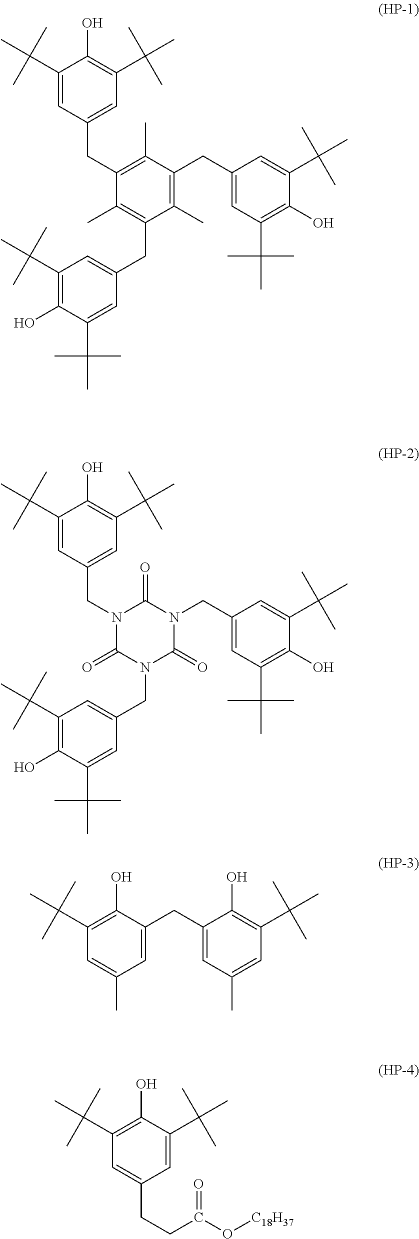

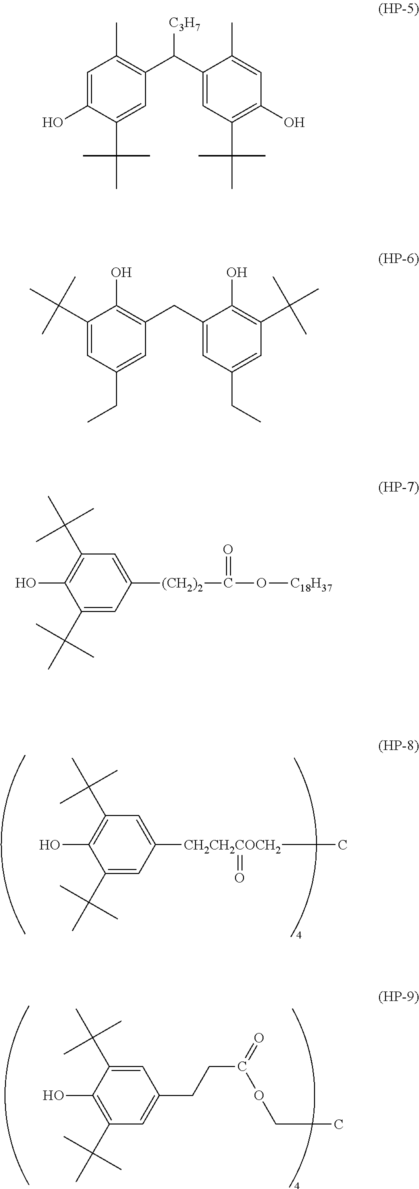

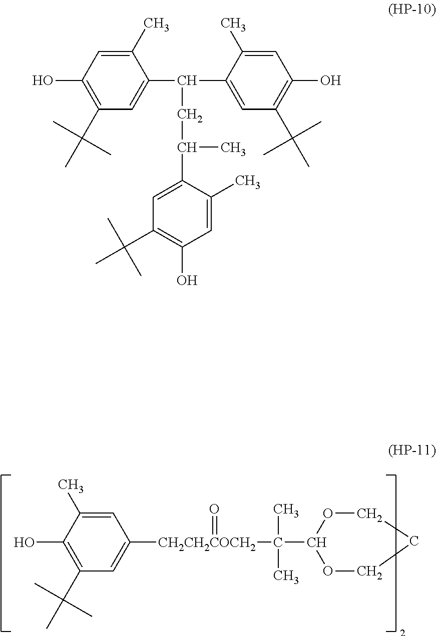

The hindered phenol antioxidant may be used alone or in combination of two or more kinds thereof.

The content of the hindered phenol antioxidant is preferably from 0.5% by weight to 10% by weight, more preferably from 0.5% by weight to 7% by weight, and still more preferably from 0.5% by weight to 3% by weight, with respect to the total amount of the charge generating materials, from the viewpoint of prevention of burn-in ghosting and light fatigue. Further, the content of this hindered phenol antioxidant is expressed in parts (parts by weight) when the content of all the charge generating materials is defined as 100 parts by weight.

Moreover, by setting the content of the hindered phenol antioxidant to equal to or less than 10% by weight, the decrease in the charge transportability of the charge transport materials by the antioxidant is prevented. That is, prevention of the formation of an electrostatic latent image on the surface of the photoreceptor by irradiation with light is prevented, and thus, an image having a desired density is easily obtained.

The binder resin for use in the charge generation layer may be selected from a wide variety of insulating resins. Further, the binder resin may be selected from organic photoconductive polymers such as poly-N-vinylcarbazole, polyvinylanthracene, polyvinylpyrene, and polysilane.

Examples of the binder resin in the charge generation layer include polyvinyl butyral resins, polyarylate resins (a polycondensate of a bisphenol and a divalent aromatic dicarboxylic acid, and the like), polycarbonate resins, polyester resins, phenoxy resins, vinyl chloride-vinyl acetate copolymers, polyamide resins, acrylic resins, polyacrylamide resins, polyvinyl pyridine resins, cellulose resins, urethane resins, epoxy resins, casein, polyvinyl alcohol resins, and polyvinyl pyrrolidone resins. The term “being insulating” herein refers to having a volume resistivity of equal to or more than 10¹³ Ωcm.

The binder resin may be used alone or as a mixture of two or more kinds thereof.

Moreover, the blend ratio of the charge generating material to the binder resin is preferably in the range from 10:1 to 1:10 in terms of weight ratio.

The charge generation layer may include other known additives.

A technique for forming the charge generation layer is not particularly limited, and known forming methods are used. For example, formation of the charge generation layer is carried out by forming a coating film of a coating liquid for forming a charge generation layer in which the components are added to a solvent, and drying the coating film, followed by heating, as desired. Further, formation of the charge generation layer may be carried out by vapor deposition of the charge generating materials. Formation of the charge generation layer by vapor deposition is particularly suitable in the case where a fused aromatic pigment or a perylene pigment is used as the charge generating material.

Examples of the solvent for preparing the coating liquid for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents may be used alone or as a mixture of two or more kinds thereof.

For a method for dispersing particles (for example, charge generating materials) in the coating liquid for forming a charge generation layer, media dispersers such as a ball mill, a vibratory ball mill, an attritor, a sand mill, and a horizontal sand mill or a medialess disperser such as a stirrer, an ultrasonic disperser, a roller mill, and a high-pressure homogenizer are used. Examples of the high-pressure homogenizer include a collision-type homogenizer in which dispersing is performed by subjecting the dispersion to liquid-liquid collision or liquid-wall collision in a high-pressure state and a penetration-type homogenizer in which dispersing is performed by causing the dispersion to penetrate fine channels in a high pressure state.

Incidentally, during the dispersion, it is effective to adjust the average particle diameter of the charge generating material in the coating liquid for forming a charge generation layer to equal to or less than 0.5 μm, preferably equal to or less than 0.3 μm, and more preferably equal to or less than 0.15 μm.

Examples of the method for applying the undercoat layer (or the intermediate layer) with the coating liquid for forming a charge generation layer include common methods such as a blade coating method, a wire bar coating method, a spray coating method, a dipping coating method, a bead coating method, an air knife coating method, and a curtain coating method.

The film thickness of the charge generation layer is set to be, for example, preferably in the range from 0.1 μm to 5.0 μm, and more preferably in the range from 0.2 μm to 2.0 μm.

### Charge Transport Material

The charge transport layer is a layer including, for example, a charge transport material and a binder resin.

As the charge transport material, a butadiene charge transport material (CT1) and a benzidine charge transport material (CT2) are applied.

The butadiene charge transport material (CT1) will be described.

The butadiene charge transport material (CT1) is a charge transport material represented by the following formula (CT1).

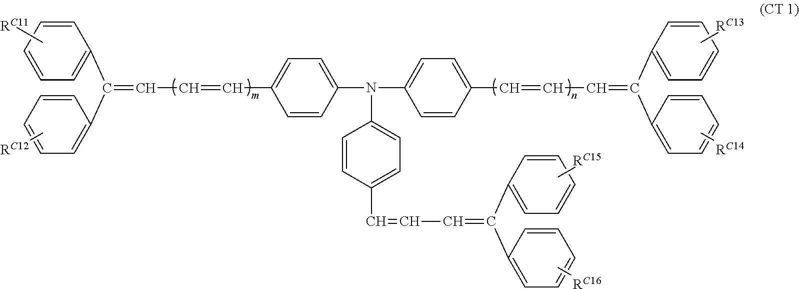

In formula (CT1) , R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, and two adjacent substituents may be bonded to each other to form a hydrocarbon ring structure. n and m each independently represent 0, 1, or 2.

In formula (CT1), examples of the halogen atoms represented by R^{C11}, R^{C12}, R^{C13}, R^{C14}, R^{C15}, and R^{C16} include a fluorine atom, a chlorine atom, a bromine atom, and an iodine atom. Among these, as the halogen atom, a fluorine atom and a chlorine atom are preferable, and a chlorine atom is more preferable.

In formula (CT1), examples of the alkyl groups represented by R^{C11}, R^{C12}, R^{C13}, R^{C14}, R^{C15}, and R^{C16} include a linear or branched alkyl group having from 1 to 20 carbon atoms (preferably having from 1 to 6 carbon atoms, and more preferably having from 1 to 4 carbon atoms).

Specific examples of the linear alkyl group include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, a n-hexadecyl group, a n-heptadecyl group, a n-octadecyl group, a n-nonadecyl group, and a n-eicosyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, a neoundecyl group, an isododecyl group, a sec-dodecyl group, a tert-dodecyl group, a neododecyl group, an isotridecyl group, a sec-tridecyl group, a tert-tridecyl group, a neotridecyl group, an isotetradecyl group, a sec-tetradecyl group, a tert-tetradecyl group, a neotetradecyl group, a 1-isobutyl-4-ethyloctyl group, an isopentadecyl group, a sec-pentadecyl group, a tert-pentadecyl group, a neopentadecyl group, an isohexadecyl group, a sec-hexadecyl group, a tert-hexadecyl group, a neohexadecyl group, a 1-methylpentadecyl group, an isoheptadecyl group, a sec-heptadecyl group, a tert-heptadecyl group, a neoheptadecyl group, an isooctadecyl group, a sec-octadecyl group, a tert-octadecyl group, a neooctadecyl group, an isononadecyl group, a sec-nonadecyl group, a tert-nonadecyl group, a neononadecyl group, a 1-methyloctyl group, an isoeicosyl group, a sec-eicosyl group, a tert-eicosyl group, and a neoeicosyl group.

Among these, lower alkyl groups such as a methyl group, an ethyl group, and an isopropyl group are preferable as the alkyl group.

In formula (CT1), examples of the alkoxy groups represented by R^{C11}, R^{C12}, R^{C13}, R^{C14}, R^{C15}, and R^{C16} include a linear or branched alkoxy group having from 1 to 20 carbon atoms (preferably having from 1 to 6 carbon atoms, and more preferably having from 1 to 4 carbon atoms).

Specific examples of the linear alkoxy group include a methoxy group, an ethoxy group, a n-propoxy group, a n-butoxy group, a n-pentyloxy group, a n-hexyloxy group, a n-heptyloxy group, a n-octyloxy group, a n-nonyloxy group, a n-decyloxy group, a n-undecyloxy group, a n-dodecyloxy group, a n-tridecyloxy group, a n-tetradecyloxy group, a n-pentadecyloxy group, a n-hexadecyloxy group, a n-heptadecyloxy group, a n-octadecyloxy group, a n-nonadecyloxy group, and a n-eicosyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, an isoundecyloxy group, a sec-undecyloxy group, a tert-undecyloxy group, a neoundecyloxy group, an isododecyloxy group, a sec-dodecyloxy group, a tert-dodecyloxy group, a neododecyloxy group, an isotridecyloxy group, a sec-tridecyloxy group, a tert-tridecyloxy group, a neotridecyloxy group, an isotetradecyloxy group, a sec-tetradecyloxy group, a tert-tetradecyloxy group, a neotetradecyloxy group, a 1-isobutyl-4-ethyloctyloxy group, an isopentadecyloxy group, a sec-pentadecyloxy group, a tert-pentadecyloxy group, a neopentadecyloxy group, an isohexadecyloxy group, a sec-hexadecyloxy group, a tert-hexadecyloxy group, a neohexadecyloxy group, a 1-methylpentadecyloxy group, an isoheptadecyloxy group, a sec-heptadecyloxy group, a tert-heptadecyloxy group, a neoheptadecyloxy group, an isooctadecyloxy group, a sec-octadecyloxy group, a tert-octadecyloxy group, a neooctadecyloxy group, an isononadecyloxy group, a sec-nonadecyloxy group, a tert-nonadecyloxy group, a neononadecyloxy group, a 1-methyloctyloxy group, an isoeicosyloxy group, a sec-eicosyloxy group, a tert-eicosyloxy group, and a neoeicosyloxy group.

Among these, a methoxy group is preferable as the alkoxy group.

In formula (CT1), examples of the aryl groups represented by R^{C11}, R^{C12}, R^{C13}, R^{C14}, R^{C15}, and R^{C16} include an aryl group having from 6 to 30 carbon atoms (preferably having from 6 to 20 carbon atoms, and more preferably having from 6 to 16 carbon atoms).

Specific examples of the aryl group include a phenyl group, a naphthyl group, a phenanthryl group, and a biphenylyl group.

Among these, a phenyl group and a naphthyl group are preferable as the aryl group.

Furthermore, in formula (CT1), the respective substituents represented by R^{C11}, R^{C12}, R^{C13}, R^{C14}, R^{C15}, and R^{C16} also include groups further having substituents. Examples of the substituents include atoms and groups exemplified above (for example, a halogen atom, an alkyl group, an alkoxy group, and an aryl group).

In formula (CT1), examples of the groups linking the substituents in the hydrocarbon ring structures in which two adjacent substituents (for example, R^{C11} and R^{C12}, R^{C13} and R^{C14}, and R^{C15} and R^{C16}) of R^{C11}, R^{C12}, R^{C13}, R^{C14}, R^{C15}, and R^{C16} are linked to each other include a single bond, a 2,2′-methylene group, a 2,2′-ethylene group, and a 2,2′-vinylene group, and among these, a single bond and a 2,2′-methylene group are preferable.

Here, specific examples of the hydrocarbon ring structure include a cycloalkane structure, a cycloalkene structure, and a cycloalkanepolyene structure.

In formula (CT1), n and m are preferably 1.

In formula (CT1), from the viewpoint of forming a charge transport layer having high charge transportability, it is preferable that R^{C11}, R^{C12}, R^{C13}, R^{C14}, R^{C15}, and R^{C16} each represent a hydrogen atom, an alkyl group having from 1 to 20 carbon atoms, or an alkoxy group having from 1 to 20 carbon atoms, and m and n each represent 1 or 2, and it is more preferable that R^{cil}, R^{C12}, R^{C13}, R^{C14}, R^{C15}, and R^{C16} each represent a hydrogen atom, and m and n each represent 1.

That is, it is more preferable that the butadiene charge transport material (CT1) is a charge transport material (exemplary compound (CT1-3)) represented by the following Structural Formula (CT1A).

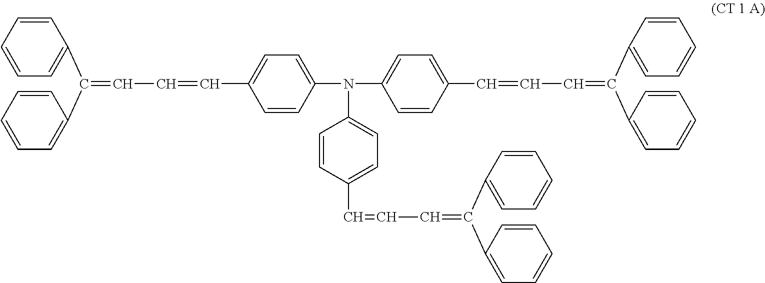 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

Specific examples of the butadiene charge transport material (CT1) are shown below, and are not limited thereto.

| Exemplary | | | | | | | | |
|---|---|---|---|---|---|---|---|---|
| compound No. | m | n | R^{C11} | R^{C12} | R^{C13} | R^{C14} | R^{C15} | R^{C16} |
| CT1-1 | 1 | 1 | 4-CH₃ | 4-CH₃ | 4-CH₃ | 4-CH₃ | H | H |
| CT1-2 | 2 | 2 | H | H | H | H | 4-CH₃ | 4-CH₃ |
| CT1-3 | 1 | 1 | H | H | H | H | H | H |
| CT1-4 | 2 | 2 | H | H | H | H | H | H |
| CT1-5 | 1 | 1 | 4-CH₃ | 4-CH₃ | 4-CH₃ | H | H | H |
| CT1-6 | 0 | 1 | H | H | H | H | H | H |
| CT1-7 | 0 | 1 | 4-CH₃ | 4-CH₃ | 4-CH₃ | 4-CH₃ | 4-CH₃ | 4-CH₃ |
| CT1-8 | 0 | 1 | 4-CH₃ | 4-CH₃ | H | H | 4-CH₃ | 4-CH₃ |
| CT1-9 | 0 | 1 | H | H | 4-CH₃ | 4-CH₃ | H | H |
| CT1-10 | 0 | 1 | H | H | 3-CH₃ | 3-CH₃ | H | H |
| CT1-11 | 0 | 1 | 4-CH₃ | H | H | H | 4-CH₃ | H |
| CT1-12 | 0 | 1 | 4-OCH₃ | H | H | H | 4-OCH₃ | H |
| CT1-13 | 0 | 1 | H | H | 4-OCH₃ | 4-OCH₃ | H | H |
| CT1-14 | 0 | 1 | 4-OCH₃ | H | 4-OCH₃ | H | 4-OCH₃ | 4-OCH₃ |
| CT1-15 | 0 | 1 | 3-CH₃ | H | 3-CH₃ | H | 3-CH₃ | H |
| CT1-16 | 1 | 1 | 4-CH₃ | 4-CH₃ | 4-CH₃ | 4-CH₃ | 4-CH₃ | 4-CH₃ |
| CT1-17 | 1 | 1 | 4-CH₃ | 4-CH₃ | H | H | 4-CH₃ | 4-CH₃ |
| CT1-18 | 1 | 1 | H | H | 4-CH₃ | 4-CH₃ | H | H |
| CT1-19 | 1 | 1 | H | H | 3-CH₃ | 3-CH₃ | H | H |
| CT1-20 | 1 | 1 | 4-CH₃ | H | H | H | 4-CH₃ | H |
| CT1-21 | 1 | 1 | 4-OCH₃ | H | H | H | 4-OCH₃ | H |
| CT1-22 | 1 | 1 | H | H | 4-OCH₃ | 4-OCH₃ | H | H |
| CT1-23 | 1 | 1 | 4-OCH₃ | H | 4-OCH₃ | H | 4-OCH₃ | 4-OCH₃ |
| CT1-24 | 1 | 1 | 3-CH₃ | H | 3-CH₃ | H | 3-CH₃ | H |

Furthermore, the abbreviated symbols in the exemplary compounds represent the following meanings. Further, the numbers attached before the substituents represent the substitution positions with respect to the benzene ring.
—CH₃: Methyl group
—OCH₃: Methoxy group

The butadiene charge transport material (CT1) may be used alone or in combination of two or more kinds thereof.

The benzidine charge transport material (CT2) will be described.

The benzidine charge transport material (CT2) is a charge transport material represented by the following formula (CT2).

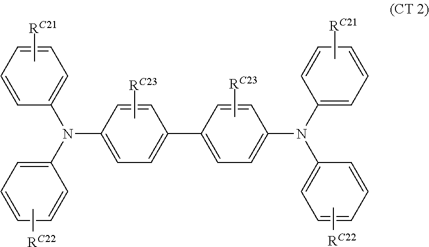

In formula (CT2), R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

In formula (CT2), examples of the halogen atoms represented by R^{C21}, R^{C22}, and R^{C23} include a fluorine atom, a chlorine atom, a bromine atom, and an iodine atom. Among these, as the halogen atom, a fluorine atom and a chlorine atom are preferable, and a chlorine atom is more preferable.

In formula (CT2), examples of the alkyl groups represented by R^{C21}, R^{C22}, and R^{C23} include a linear or branched alkyl group having from 1 to 10 carbon atoms (preferably having from 1 to 6 carbon atoms, and more preferably having from 1 to 4 carbon atoms).

Specific examples of the linear alkyl group include a methyl group, an ethyl group, a n-propyl group, a n-butyl group, a n-pentyl group, a n-hexyl group, a n-heptyl group, a n-octyl group, a n-nonyl group, and a n-decyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Among these, lower alkyl groups such as a methyl group, an ethyl group, and an isopropyl group are preferable as the alkyl group.

In formula (CT2), examples of the alkoxy groups represented by R^{C21}, R^{C22}, and R^{C23} include a linear or branched alkoxy group having from 1 to 10 carbon atoms (preferably having from 1 to 6 carbon atoms, and more preferably having from 1 to 4 carbon atoms).

Specific examples of the linear alkoxy group include a methoxy group, an ethoxy group, a n-propoxy group, a n-butoxy group, a n-pentyloxy group, a n-hexyloxy group, a n-heptyloxy group, a n-octyloxy group, a n-nonyloxy group, and a n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Among these, a methoxy group is preferable as the alkoxy group.

In formula (CT2) , examples of the aryl groups represented by R^{C21}, R^{C22}, and R^{C23} include an aryl group having from 6 to 10 carbon atoms (preferably having from 6 to 9 carbon atoms, and more preferably having from 6 to 8 carbon atoms).

Specific examples of the aryl group include a phenyl group and a naphthyl group.

Among these, a phenyl group is preferable as the aryl group.

Moreover, in formula (CT2), the respective substituents represented by R^{C21}, R^{C22}, and R^{C23} also include groups further having substituents. Examples of the substituents include atoms and groups exemplified above (for example, a halogen atom, an alkyl group, an alkoxy group, and an aryl group).

In formula (CT2), particularly from the viewpoint of forming a charge transport layer having high charge transportability, it is preferable that R^{C21}, R^{C22}, and R^{C23} each independently represent a hydrogen atom or an alkyl group having from 1 to 10 carbon atoms, and it is more preferable that R^{C21} and R^{C23} represent a hydrogen atom, and R^{C22} represents an alkyl group having from 1 to 10 carbon atoms (particularly a methyl group).

Specifically, it is particularly preferable that the benzidine charge transport material (CT2) is a charge transport material (exemplary compound (CT2-2)) represented by the following Structural formula (CT2A).

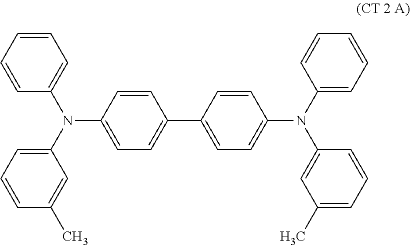 [SMILES: Cc1cccc(N(c2ccccc2)c2ccc(-c3ccc(N(c4ccccc4)c4cccc(C)c4)cc3)cc2)c1]

Specific examples of the benzidine charge transport material (CT2) are shown below, and are not limited thereto.

| Exemplary | | | |
|---|---|---|---|
| compound No. | R^{C21} | R^{C22} | R^{C23} |
| CT2-1 | H | H | H |
| CT2-2 | H | 3-CH₃ | H |
| CT2-3 | H | 4-CH₃ | H |
| CT2-4 | H | 3-C₂H₅ | H |
| CT2-5 | H | 4-C₂H₅ | H |
| CT2-6 | H | 3-OCH₃ | H |
| CT2-7 | H | 4-OCH₃ | H |
| CT2-8 | H | 3-OC₂H₅ | H |
| CT2-9 | H | 4-OC₂H₅ | H |
| CT2-10 | 3-CH₃ | 3-CH₃ | H |
| CT2-11 | 4-CH₃ | 4-CH₃ | H |
| CT2-12 | 3-C₂H₅ | 3-C₂H₅ | H |
| CT2-13 | 4-C₂H₅ | 4-C₂H₅ | H |
| CT2-14 | H | H | 2-CH₃ |
| CT2-15 | H | H | 3-CH₃ |
| CT2-16 | H | 3-CH₃ | 2-CH₃ |
| CT2-17 | H | 3-CH₃ | 3-CH₃ |
| CT2-18 | H | 4-CH₃ | 2-CH₃ |
| CT2-19 | H | 4-CH₃ | 3-CH₃ |
| CT2-20 | 3-CH₃ | 3-CH₃ | 2-CH₃ |
| CT2-21 | 3-CH₃ | 3-CH₃ | 3-CH₃ |
| CT2-22 | 4-CH₃ | 4-CH₃ | 2-CH₃ |
| CT2-23 | 4-CH₃ | 4-CH₃ | 3-CH₃ |

Furthermore, the abbreviated symbols in the exemplary compounds represent the following meanings. Further, the numbers attached before the substituents represent the substitution positions with respect to the benzene ring.
—CH₃: Methyl group
—C₂H₅: Ethyl group
—OCH₃: Methoxy group
—OC₂H₅: Ethoxy group

The benzidine charge transport material (CT2) may be used alone or in combination of two or more kinds thereof.

Next, the content of the charge transport material will be described.

With respect to the content of the butadiene charge transport material (CT1), the blend ratio of CT1 to the binder resin (weight ratio of CT1: binder resin) is preferably in the range from 0.1:9.9 to 4.0:6.0, more preferably in the range from 0.4:9.6 to 3.5:6.5, and still more preferably in the range from 0.6:9.4 to 3.0:7.0, from the viewpoint of forming a charge transport layer having high charge transportability.

With respect to the content of the benzidine charge transport material (CT2), the blend ratio of CT2 to the binder resin (weight ratio of CT2: binder resin) is preferably in the range from 1:9 to 7:3, more preferably in the range from 2:8 to 6:4, and still more preferably in the range from 2:8 to 4:6, from the viewpoint of forming a charge transport layer having high charge transportability.

The weight ratio of the content of the butadiene charge transport material (CT1) to the content of the benzidine charge transport material (CT2) (the content of butadiene charge transport material (CT1)/the content of the benzidine charge transport material (CT2)) is preferably in the range from 1/9 to 5/5, more preferably in the range from 1/9 to 4/6, and still more preferably in the range from, 1/9 to 3/7, from the viewpoint of forming a charge transport layer having high charge transportability.

In particular, if the weight ratio of the content of the butadiene charge transport material (CT1) to the content of the benzidine charge transport material (CT2) is within the above range, burn-in ghosting and light fatigue easily occur, but by the hindered phenol antioxidant included in the charge generation layer, occurrence of burn-in ghosting and light fatigue is prevented.

Moreover, charge transport materials other than the butadiene charge transport material (CT1) and the benzidine charge transport material (CT2) may also be used in combination with others. Here, in such a case, the content of the charge transport materials with respect to all the charge transport materials is preferably equal to or less than 10% by weight (preferably equal to or less than 5% by weight).

Examples of the binder resin for use in the charge transport layer include polycarbonate resins, polyester resins, polyarylate resins, methacrylic resins, acrylic resins, polyvinyl chloride resins, polyvinylidene chloride resins, polystyrene resins, polyvinyl acetate resins, styrene-butadiene copolymers, vinylidene chloride-acrylonitrile copolymers, vinyl chloride-vinyl acetate copolymers, vinyl chloride-vinyl acetate-maleic anhydride copolymers, silicone resins, silicone alkyd resins, phenol-formaldehyde resins, styrene-alkyd resins, poly-N-vinylcarbazole, and polysilane. Among these, polycarbonate resins or polyarylate resins are suitable as the binder resin. These binder resins may be used alone or in combination of two or more kinds thereof.

In addition, the blend ratio of the charge transport material to the binder resin is preferably from 10:1 to 1:5 in terms of weight ratio.

The charge transport layer may contain other known additives.

A technique for forming the charge transport layer is not particularly limited, and known forming methods are used. For example, formation of the charge transport layer is carried out by forming a coating film of a coating liquid for forming a charge transport layer, prepared by adding the components to a solvent, and then drying the coating film, followed by heating as desired.

Examples of the solvent for preparing the coating liquid for forming a charge transport layer are common organic solvents including, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents may be used alone or as a mixture of two or more kinds thereof.

Examples of a coating method used in coating the charge generation layer with the coating liquid for forming a charge transport layer include common methods such as a blade coating method, a wire bar coating method, a spray coating method, a dipping coating method, a bead coating method, an air knife coating method, and a curtain coating method.

The film thickness of the charge transport layer is, for example, set to be in the range from preferably 5 μm to 50 μm and more preferably from 10 μm to 30 μm.

### Protective Layer

The protective layer is provided on the photosensitive layer, as desired. The protective layer is provided, for example, for the purpose of preventing the chemical changes of the photosensitive layer during charging, and further improving the mechanical strength of the photosensitive layer.

Accordingly, as the protective layer, a layer formed of a cured film (crosslinked film) may be applied. Examples of this layer include the layers described in 1) and 2) below.

1) A layer formed of a cured film of a composition that includes a reactive group-containing charge transport material that has a reactive group and a charge transporting skeleton in the same molecule (that is, a layer that includes a polymer or a crosslinked product of the reactive group-containing charge transport material)

2) A layer formed of a cured film of a composition that includes an unreactive charge transport material and a reactive group-containing non-charge transport material that has no charge transporting skeleton but has a reactive group (that is, a layer that includes a polymer or a crosslinked product of an unreactive charge transport material and a reactive group-containing non-charge transport material).

Examples of the reactive group of the reactive group-containing charge transport material include known reactive groups such as a chain polymerizable group, an epoxy group, —OH, —OR [in which R represents an alkyl group], —NH₂, —SH, —COOH, and —SiR^{Q1}_{3-Qn}(OR^{Q2})_{Qn} [in which R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long it is a radically polymerizable functional group. For example, it is a functional group which has at least a group containing a carbon-carbon double bond. Specific examples thereof include a group that contains at least one selected from the group consisting of a vinyl group, a vinyl ether group, a vinyl thioether group, a styryl group, a vinylphenyl group, an acryloyl group, a methacryloyl group, and derivatives thereof. Among these, a group that contains at least one selected from the group consisting of a vinyl group, a styryl group, a vinylphenyl group, an acryloyl group, a methacryloyl group, and derivatives thereof is preferable as the chain polymerizable group from the viewpoint of its excellent reactivity.

The charge transporting skeleton of the reactive group-containing charge transport material is not particularly limited as long as it is a known structure for an electrophotographic photoreceptor. Examples thereof include skeletons derived from nitrogen-containing hole transport compounds such as triarylamine compounds, benzidine compounds, and hydrazone compounds, in which the structure is conjugated with a nitrogen atom. Among these, a triarylamine skeleton is preferable.

The reactive group-containing charge transport material having a reactive group and a charge transporting skeleton, the unreactive charge transport material, and the reactive group-containing non-charge transport material may be selected from known materials.

The protective layer may further include other known additives.

A technique for forming the protective layer is not particularly limited, and known methods are used. For example, the formation is carried out by forming a coating film from a coating liquid for forming a protective layer, prepared by adding the components to a solvent, and drying the coating film, followed by a curing treatment such as heating, as desired.

Examples of the solvent used for preparing the coating liquid for forming a protective layer include aromatic solvents such as toluene and xylene; ketone solvents such as methyl ethyl ketone, methyl isobutyl ketone, and cyclohexanone; ester solvents such as ethyl acetate and butyl acetate; ether solvents such as tetrahydrofuran and dioxane; cellosolve solvents such as ethylene glycol monomethyl ether; and alcohol solvents such as isopropyl alcohol and butanol. These solvents may be used alone or as a mixture of two or more kinds thereof.

Furthermore, the coating liquid for forming a protective layer may be a solvent-free coating liquid.

Examples of the coating method used for coating the photosensitive layer (for example, the charge transport layer) with the coating liquid for forming a protective layer include common methods such as a dipping coating method, a lift coating method, a wire bar coating method, a spray coating method, a blade coating method, a knife coating method, and a curtain coating method.

The film thickness of the protective layer is set to be, for example, preferably in the range from 1 μm to 20 μm, and more preferably in the range from 2 μm to 10 μm.

Image Forming Apparatus (and Process Cartridge)

The image forming apparatus according to the exemplary embodiment includes an electrophotographic photoreceptor, a charging device that charges the surface of the electrophotographic photoreceptor, an electrostatic latent image forming device that forms an electrostatic latent image on the charged surface of the electrophotographic photoreceptor, a developing device that accommodates a developer including a toner, and develops the electrostatic latent image formed on the surface of the electrophotographic photoreceptor by a developer including a toner to form a toner image, and a transfer device that transfers the toner image onto the surface of a recording medium. Further, the electrophotographic photoreceptor according to the exemplary embodiment is applied as the electrophotographic photoreceptor.

As the image forming apparatus according to the exemplary embodiment, there is applied a known image forming apparatus including a device including a fixing device that fixes a toner image transferred onto the surface of a recording medium; a direct transfer mode device that directly transfers a toner image formed on the surface of the electrophotographic photoreceptor onto a recording medium; an intermediate transfer mode device that primarily transfers a toner image formed on the surface of the electrophotographic photoreceptor onto the surface of an intermediate transfer member, and secondarily transfers a toner image transferred on the surface of a intermediate transfer member onto the surface of a recording medium; a device including a cleaning device that cleans the surface of the electrophotographic photoreceptor after transferring the toner image and before charging the surface of the electrophotographic photoreceptor; a device including a charge erasing device that erases the charge by irradiating the surface of the electrophotographic photoreceptor with charge erasing light after transferring the toner image and before charging the surface of the electrophotographic photoreceptor; and a device including an electrophotographic photoreceptor heating member that raises the temperature of an electrophotographic photoreceptor and lowers the relative temperature.

In the case of the intermediate transfer mode device, for example, a configuration including an intermediate transfer member in which a toner image is transferred to the surface, a primary transfer device that primarily transfers the toner image formed on the surface of the electrophotographic photoreceptor onto the surface of an intermediate transfer member, and a secondary transfer device that secondarily transfers the toner image transferred onto the surface of the intermediate transfer member onto the surface of the recording medium is applied to the transfer device.

The image forming apparatus according to the exemplary embodiment may be either an image forming apparatus of dry development type or an image forming apparatus of a wet development type (a development type using a liquid developer).

Furthermore, in the image forming apparatus according to the exemplary embodiment, for example, a portion including the electrophotographic photoreceptor may be a cartridge structure (process cartridge) that is detachable from the image forming apparatus. As the process cartridge, for example, a process cartridge including the electrophotographic photoreceptor according to the exemplary embodiment is suitably used. Further, the process cartridge may further include, in addition to the electrophotographic photoreceptor, for example, at least one selected from the group consisting of a charging device, an electrostatic latent image forming device, a developing device, and a transfer device.

One example of the image forming apparatus according to the exemplary embodiment is shown below, but is not limited thereto. Further, the main portions shown in the drawings are described, and descriptions of the other portions will be omitted.

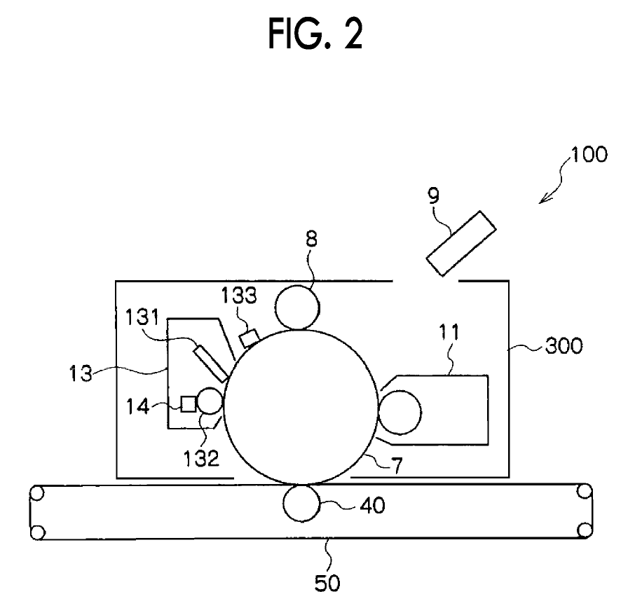

FIG. 2 is a schematic configuration diagram showing one example of the image forming apparatus according to the exemplary embodiment.

As shown in FIG. 2, the image forming apparatus 100 according to the exemplary embodiment includes a process cartridge 300 including an electrophotographic photoreceptor 7, an exposure device 9 (one examples of an electrostatic latent image forming device), a transfer device 40 (a primary transfer device), and an intermediate transfer member 50. Further, in the image forming apparatus 100, the exposure device 9 is disposed at a position where the electrophotographic photoreceptor 7 may be exposed through the opening of the process cartridge 300, the transfer device 40 is disposed at a position opposite to the electrophotographic photoreceptor 7 through the intermediate transfer member 50, and the intermediate transfer member 50 is disposed such that a part thereof contacts with the electrophotographic photoreceptor 7. Although not shown, the image forming apparatus 100 further has a secondary transfer device configured to transfer the toner image transferred onto the intermediate transfer member 50 onto a recording medium (for example, a paper sheet). In addition, the intermediate transfer member 50, the transfer device 40 (a primary transfer device), and the secondary transfer device (not shown) correspond to one example of the transfer device.

The process cartridge 300 in FIG. 2 supports an electrophotographic photoreceptor 7, a charging device 8 (one example of a charging device), a developing device 11 (one example of a developing device), and a cleaning device 13 (one example of a cleaning device) in a housing in an integrated manner. The cleaning device 13 has a cleaning blade 131 (one example of a cleaning member). The cleaning blade 131 is arranged to contact with a surface of the electrophotographic photoreceptor 7. The cleaning member may be a conductive or insulating fibrous member instead of the form of the cleaning blade 131, and may be used alone or in combination with the cleaning blade 131.

Furthermore, an example of an image forming apparatus which includes a fibrous member 132 (roller-shaped) that supplies a lubricating member 14 to the surface of the electrophotographic photoreceptor 7, and a fibrous member 133 (flat brush-shaped) that assists cleaning is shown in FIG. 2, but these may be disposed, as desired.

Hereinafter, each configuration of the image forming apparatus according to the exemplary embodiment will be described.

### Charging Device

As the charging device 8, for example, a contact type charger using a conductive or semiconductive charging roller, a charging brush, a charging film, a charging rubber blade, a charging tube, or the like is used. Further, known chargers such as a non-contact type roller charger, a scorotron charger, and a corotron charger using corona discharge are also used.

### Exposure Device

Examples of the exposure device 9 include an optical instrument which exposes, in a predetermined imagewise manner, the surface of the electrophotographic photoreceptor 7 to light such as a semiconductor laser light, an LED light, or a liquid crystal shutter light. For the wavelength of the light source, a wavelength that belongs to the spectral sensitivity region of the electrophotographic photoreceptor is used. The principal range of the wavelength of the semiconductor laser light is near-infrared having an emission wavelength at near 780 nm. However, the wavelength of the light source is not limited to this wavelength, and a laser light having an emission wavelength in the band of 600 nm, or a blue laser light having an emission wavelength from 400 nm to 450 nm may also be used. Further, a surface light-emitting type laser light source that may output multiple beams is also effective for the formation of color images.

### Developing Device

Examples of the developing device 11 include a general developing device which performs development using a developer in a contact or non-contact manner. The developing device 11 is not particularly limited as long as the device has the function described above, and is selected according to the purpose. For example, a known developing machine having a function of attaching a single-component developer or a two-component developer to the electrophotographic photoreceptor 7 using a brush, a roller or the like, may be mentioned. Among these, it is preferable to use a developing device employing a developing roller which holds the developer at the surface.

The developer for use in the developing device 11 may be a single-component developer configured by a toner alone or a two-component developer that includes a toner and a carrier. Further, the developer may be magnetic or nonmagnetic. As the developer, a known developer is applied.

### Cleaning Device

A cleaning blade type device including a cleaning blade 131 is used as the cleaning device 13.

Furthermore, instead of the cleaning blade type, a fur brush cleaning type or a type conducting cleaning and development simultaneously may be employed.

### Transfer Device

Examples of the transfer device 40 include known transfer chargers such as a contact-type transfer charger using a belt, a roller, a film, a rubber blade, or the like, and scorotron transfer chargers and corotron transfer chargers, each utilizing corona discharge.

### Intermediate Transfer Member

As the intermediate transfer member 50, belt-shaped transfer members (intermediate transfer belts) including polyimide, polyamideimide, polycarbonate, polyarylate, polyester, rubber, or the like, which have been imparted with semiconductivity, are used. Further, in regard to the shape of the intermediate transfer member, a transfer member having a drum shape may be used in addition to the belt-shaped transfer member.

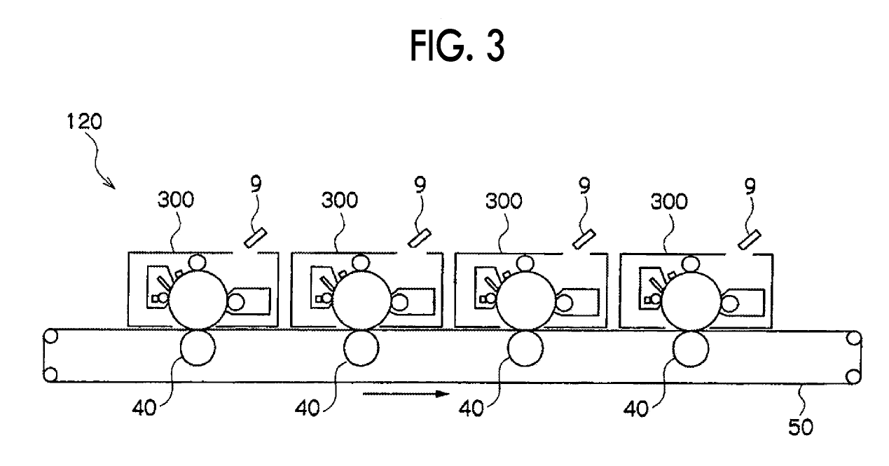

FIG. 3 is a schematic configuration diagram showing another example of the image forming apparatus according to the exemplary embodiment.

The image forming apparatus 120 shown in FIG. 3 is a tandem type multi-color image forming apparatus equipped with four process cartridges 300. The image forming apparatus 120 has a configuration in which the four process cartridges 300 are disposed in parallel on the intermediate transfer member 50, and one electrophotographic photoreceptor is used per color. Further, the image forming apparatus 120 has the same configuration as the image forming apparatus 100, except for being a tandem type.

### EXAMPLES

Hereinafter, Examples of the present invention will be described, but the present invention is not limited to the following Examples. Further, in the following description, “part(s)” and “%” are all based on weight unless otherwise specified.

### Example 1

### Preparation of Electrophotographic Photoreceptor

### Formation of Undercoat Layer

100 parts by weight of zinc oxide (trade name: MZ-300, manufactured by Tayca Corporation), 10 parts by weight of a toluene solution containing 10% by weight of N-2-(aminoethyl)-3-aminopropyltrimethoxysilane as a silane coupling agent, and 200 parts by weight of toluene are mixed, and the mixture is stirred and refluxed for 2 hours. Thereafter, toluene is distilled off under reduced pressure of 10 mmHg and the residue is subjected to a baking surface treatment at 135° C. for 2 hours.

33 parts by weight of surface-treated zinc oxide, 6 parts by weight of blocked isocyanate (trade name: SUMIDUR 3175 manufactured by Sumitomo Bayer Urethane Co., Ltd.), 1 part by weight of a compound represented by formula (AK-1), and 25 parts by weight of methyl ethyl ketone are mixed for 30 minutes. Thereafter, 5 parts by weight of a butyral resin (trade name: S-LEC BM-1, manufactured by Sekisui Chemical Co., Ltd.), 3 parts by weight of a silicone ball (trade name: TOSPEARL 120, manufactured by GE Toshiba Silicones Co., Ltd.) and 0.01 part by weight of a silicon oil as a leveling agent (trade name: SH29PA, manufactured by Dow Corning Toray Silicone Co., Ltd.) are added thereto and the mixture is dispersed for 3 hours by using a sand mill to obtain a dispersion (a coating liquid for forming an undercoat layer).

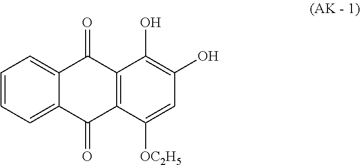 [SMILES: CCOc1cc(O)c(O)c2c1C(=O)c1ccccc1C2=O]

In addition, this coating liquid is coated onto an aluminum substrate having a diameter of 47 mm, a length of 357 mm, and a thickness of 1 mm by a dipping coating method, and dried, and cured at 180° C. for 30 minutes to obtain an undercoat layer having a thickness of 25 μm.

Formation of Charge Generation layer

Next, a mixture formed of a hydroxygallium phthalocyanine pigment “V type hydroxygallium phthalocyanine pigment that has diffraction peaks at Bragg angles (2θ±0.2°) of at least 7.3°, 16.0°, 24.9°, and 28.0° in an X-ray diffraction spectrum using CuKα characteristic X-rays (a maximum peak wavelength in an optical absorption spectrum at a wavelength ranging from 600 nm to 900 nm=820 nm, an average particle diameter=0.12 μm, a maximum particle diameter=0.2 μm, and a specific surface area: 60 m²/g)”, a vinyl chloride-vinyl acetate copolymer resin (trade name: VMCH, manufactured by Nippon Unicar Company Limited) as a binder resin, and n-butyl acetate is put into a glass bottle having a capacity of 100 mL together with 1.0 mmφ glass beads with a charging rate of 50%, and subjected to a dispersion treatment for 2.5 hours using a paint shaker to obtain a coating liquid for a charge generation layer. The content of the hydroxygallium phthalocyanine pigment with respect to a mixture of the hydroxygallium phthalocyanine pigment and the vinyl chloride-vinyl acetate copolymer resin is set to 55.0% by volume, and the solid content of the dispersion is set to 6.0% by weight. The content is calculated by setting the specific density of the hydroxygallium phthalocyanine pigment to 1.606 g/cm³, and setting the specific density of the vinyl chloride-vinyl acetate copolymer resin to 1.35 g/cm³.

The obtained coating liquid is mixed with a hindered phenol antioxidant having a structure of the structure of (AO-1) which will be described later in an amount of 0.5% by weight with respect to the total amount of the charge generating material, and the mixture is dipped and coated on the undercoat layer, and dried at 100° C. for 5 minutes to form a charge generation layer having a film thickness of 0.20 μm.

### Formation of Charge Transport Layer

Next, 340 parts by weight of tetrahydrofuran is added to 8 parts by weight of a butadiene charge transport material having a structure of formula (CT1) in which R^{C11} to R^{C16} are each described in Table 1 as a compound represented by formula (CT1); 32 parts by weight of a benzidine charge transport material having a structure of formula (CT2) in which R^{C21} to R^{C23} are each described in Table 1 as a compound represented by formula (CT2); and 60 parts by weight of a bisphenol Z-type polycarbonate resin (a molecular weight of 40,000), and dissolved therein, and the obtained coating liquid is dip-coated onto a charge generation layer and dried at 150° C. for 40 minutes to form a charge transport layer having a film thickness of 34 μm.

Through the above process, there is obtained an electrophotographic photoreceptor of Example 1, having an undercoat layer, a charge generation layer, and a charge transport layer laminated in order on an aluminum substrate.

### Examples 2 to 12

In the same manner as in Example 1 except that the charge transport material in the charge transport layer and the antioxidant in the charge generation layer are changed as shown in Table 1, respectively, electrophotographic photoreceptors of Examples 2 to 12 are prepared.

### Example 13

In the same manner as in Example 7 except that the blend amounts of the charge transport materials in the coating liquid forming a charge transport layer are changed such that the blend amount of the butadiene charge transport material is set to 16 parts by weight, and the blend amount of the benzidine charge transport material is set to 24 parts by weight, an electrophotographic photoreceptor of Example 13 is prepared.

### Example 14

In the same manner as in Example 7 except that the blend amounts of the charge transport materials in the coating liquid forming a charge transport layer are changed such that the blend amount of the butadiene charge transport material is set to 24 parts by weight, and the blend amount of the benzidine charge transport material is set to 16 parts by weight, an electrophotographic photoreceptor of Example 14 is prepared.

### Comparative Example 1

In the same manner as in Example 6 except that an antioxidant is not added in formation of the charge generation layer, an electrophotographic photoreceptor of Comparative Example 1 is prepared.

### Comparative Example 2

In the same manner as in Example 6 except that the antioxidant in formation of the charge generation layer is changed to a hindered amine antioxidant of a structure (AO-5) , an electrophotographic photoreceptor of Comparative Example 2 is prepared.

### Comparative Example 3

In the same manner as in Example 1 except that only 40 parts by weight of the butadiene charge transport material in which R^{C11} to R^{C16} in formula (CT1) have the structures described in Table 1 is used as the charge transport material in the charge transport layer, an electrophotographic photoreceptor of Comparative Example 3 is prepared.

### Comparative Example 4

In the same manner as in Example 1 except that only 40 parts by weight of the benzidine charge transport material in which R^{C21} to R^{C23} in formula (CT2) have the structures described in Table 1 is used as the charge transport material in the charge transport layer, an electrophotographic photoreceptor of Comparative Example 4 is prepared.

### Comparative Example 5

In the same manner as in Example 1 except that only 40 parts by weight of a compound represented by formula (CT3) is used as the charge transport material in the charge transport layer, an electrophotographic photoreceptor of Comparative Example 5 is prepared.

### Evaluations

The electrophotographic photoreceptor obtained in each of Examples is mounted in a modified machine of an image forming apparatus (VERSANT 2100 PRESS manufactured by Fuji Xerox Co., Ltd.), and evaluated in the following manner.

### Evaluation of Burn-In Ghosting

A grid-shaped chart image (in cyan color) is formed on 3,000 paper sheets in size A3, using the image forming apparatus in an environment of 28° C. and 85% RH, and subsequently, a full half-tone image (in cyan color) having an image density of 20% is output. The state with appearance of a grid-shaped image (ghost) is visually observed, and the difference in density between the continuous grid-shaped image output area and the non-continuous grid-shaped image output area is subjected to visual sensory evaluation (grade determination). The grade determination is carried out in scales ranging from G0 to G5 with a 0.5 G unit increment, and as the number of G is the smaller, the difference in density is the smaller, indicating that burn-in ghosting does not occur. The acceptable grade of burn-in ghosting is equal to or less than G3.5.

### Evaluation of Light Fatigue

First, prior to being mounted into the image forming apparatus of each of Examples, Comparative Examples, and Reference Examples, the electrophotographic photoreceptor is wound in black paper having openings in 2 cm×2 cm to allow only the window opening unit to be optically exposed, and kept to stand for 10 minutes under a white fluorescent lamp (1,000 Lux), thereby optically exposing the electrophotographic photoreceptor.

Next, the optically exposed electrophotographic photoreceptor is mounted in the image forming apparatus of each of Examples, Comparative Examples, and Reference Examples, and a full half-tone image (in cyan color) having an image density of 50% is output on one paper sheet in size A3.

Furthermore, the output full half-tone image is observed, the difference in density between the optically exposed area and the optically unexposed area is subjected to visual sensory evaluation (grade determination). The grade determination is carried out in scales ranging from G0 to G5 with a 0.5G unit increment, and as the number of G is the smaller, the difference in density is the smaller, indicating that light fatigue does not occur. The acceptable grade of light fatigue is equal to or less than G3.5. The image outputs are all carried out in an environment of 28° C. and 85%RH.

### Evaluation of Half-Tone Image Density

A full half-tone image (in cyan color) having an image density of 50% is output on one paper sheet in size A3.

In addition, the output full half-tone image is observed, whether a desired image density is output is investigated, and evaluated in accordance with the following criteria. The image outputs are all carried out in an environment of 28° C. and 85% RH.

A: Good

B: A little pale

C: Slightly pale

D: Pale

The electrophotographic photoreceptors of the respective Examples and Comparative Examples, and evaluation results thereof are shown in Table 1. Further, the structures of the antioxidant in the charge generation layer are as follows, and the addition amount is expressed in the ratio when the total content of the charge generating materials is defined as 100% by weight.

TABLE 1

| | Charge transport material in charge transport layer | | | | | | | | | |
|---|---|---|---|---|---|---|---|---|---|---|
| | Formula (CT1) | | | | | | | | Formula (CT2) | |
| | m | n | R^{C11} | R^{C12} | R^{C13} | R^{C14} | R^{C15} | R^{C16} | R^{C21} | R^{C22} |
| Example 1 | 1 | 1 | 4-CH₃ | 4-CH₃ | 4-CH₃ | 4-CH₃ | H | H | H | H |
| Example 2 | 1 | 1 | 4-CH₃ | 4-CH₃ | 4-CH₃ | 4-CH₃ | H | H | H | H |
| Example 3 | 2 | 2 | H | H | H | H | 4-CH₃ | 4-CH₃ | H | H |
| Example 4 | 2 | 2 | H | H | H | H | 4-CH₃ | 4-CH₃ | H | H |
| Example 5 | 1 | 1 | H | H | H | H | H | H | H | H |
| Example 6 | 1 | 1 | H | H | H | H | H | H | H | 3-CH₃ |
| Example 7 | 1 | 1 | H | H | H | H | H | H | H | 3-CH₃ |
| Example 8 | 1 | 1 | H | H | H | H | H | H | H | 3-CH₃ |
| Example 9 | 1 | 1 | H | H | H | H | H | H | H | 3-CH₃ |
| Example 10 | 1 | 1 | H | H | H | H | H | H | H | 3-CH₃ |
| Example 11 | 1 | 1 | H | H | H | H | H | H | H | 3-CH₃ |
| Example 12 | 1 | 1 | H | H | H | H | H | H | H | 3-CH₃ |
| Example 13 | 1 | 1 | H | H | H | H | H | H | H | 3-CH₄ |
| Example 14 | 1 | 1 | H | H | H | H | H | H | H | 3-CH₅ |
| Comparative | 1 | 1 | H | H | H | H | H | H | H | 3-CH₃ |
| Example 1 | | | | | | | | | | |
| Comparative | 1 | 1 | H | H | H | H | H | H | H | 3-CH₃ |
| Example 2 | | | | | | | | | | |

| | | | | | | | | | |
|---|---|---|---|---|---|---|---|---|---|
| Comparative | 1 | 1 | 4-CH₃ | 4-CH₃ | 4-CH₃ | 4-CH₃ | H | H | None |
| Example 3 | | | | | | | | | |

| | | | |
|---|---|---|---|
| Comparative | None | H | H |
| Example 4 | | | |

| Comparative | None (CT3 used) | | | | | | | |
|---|---|---|---|---|---|---|---|---|
| Example 5 | | | | | | | | |
| | Charge transport material | | Antioxidant in charge | | | | | |
| | in charge transport layer | | generation layer | | | | | |
| | | Blend ration | | | Addition | | | |
| | Formula | CT1/CT2 | | | amount | Evaluation results | | |
| | (CT2) | (based on | | Molecular | (% by | Burn-in | Light | Half-tone |
| | R^{C23} | weight) | Structure | weight | weight) | ghosting | fatigue | density |
| Example 1 | H | 2/8 | AO-1 | 775 | 0.5 | 3.5G | 3.5G | A |
| Example 2 | H | 2/8 | AO-2 | 784 | 0.5 | 3.5G | 3.5G | A |
| Example 3 | H | 2/8 | AO-1 | 775 | 0.5 | 3.5G | 3.5G | A |
| Example 4 | H | 2/8 | AO-2 | 784 | 0.5 | 3.5G | 3.5G | A |
| Example 5 | H | 2/8 | AO-1 | 775 | 0.5 | 3.0G | 2.5G | A |
| Example 6 | H | 2/8 | AO-1 | 775 | 0.5 | 2.0G | 2.0G | A |
| Example 7 | H | 2/8 | AO-3 | 340 | 0.5 | 0.0G | 0.0G | A |
| Example 8 | H | 2/8 | AO-3 | 340 | 3.0 | 0.0G | 0.0G | B |
| Example 9 | H | 2/8 | AO-3 | 340 | 5.0 | 0.0G | 0.0G | B |
| Example 10 | H | 2/8 | AO-3 | 340 | 7.0 | 0.0G | 0.0G | C |
| Example 11 | H | 2/8 | A0-3 | 340 | 10.0 | 0.0G | 0.0G | D |
| Example 12 | H | 2/8 | A0-4 | 220 | 0.5 | 3.5G | 3.5G | A |
| Example 13 | H | 4/6 | A0-3 | 340 | 0.5 | 3.5G | 3.5G | A |
| Example 14 | H | 6/4 | A0-3 | 340 | 0.5 | 3.5G | 3.5G | A |
| Comparative | H | 2/8 | None | | 0.0 | 5.0G | 5.0G | A |
| Example 1 | | | | | | | | |
| Comparative | H | 2/8 | A0-5 | 481 | 0.5 | 5.0G | 5.0G | A |
| Example 2 | | | | | | | | |
| Comparative | None | — | A0-1 | 775 | 0.5 | 5.0G | 5.0G | D |
| Example 3 | | | | | | | | |
| Comparative | H | — | A0-1 | 775 | 0.5 | 5.0G | 5.0G | D |
| Example 4 | | | | | | | | |
| Comparative | None (CT3 used) | — | A0-1 | 775 | 0.5 | 5.0G | 5.0G | D |
| Example 5 | | | | | | | | |

From the above results, it may be seen that in the present Examples, “burn-in ghosting” is prevented and “light fatigue” is also prevented, as compared with Comparative Examples.

The structures of the antioxidant in Table 1 are as follows.

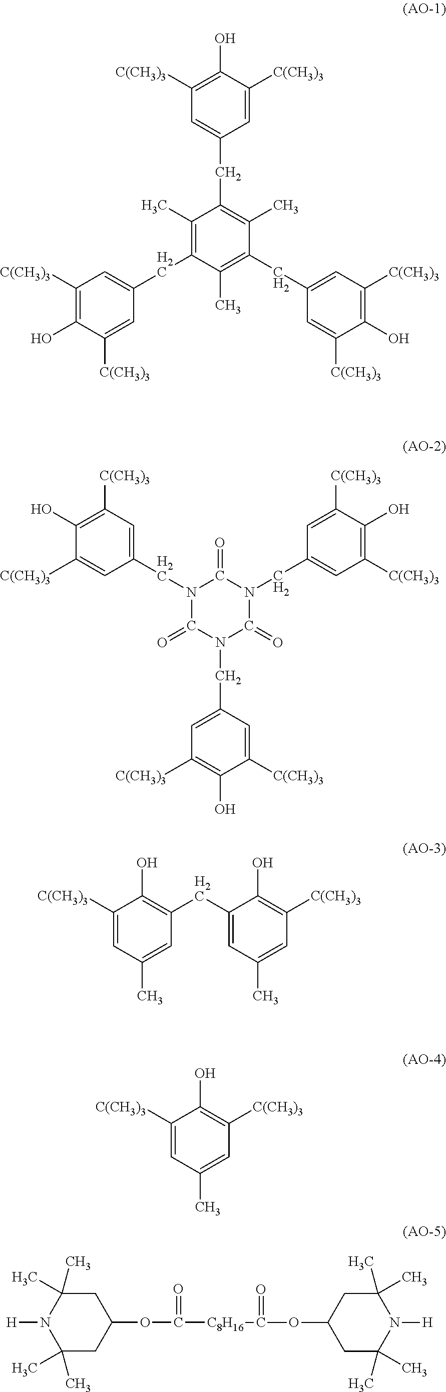

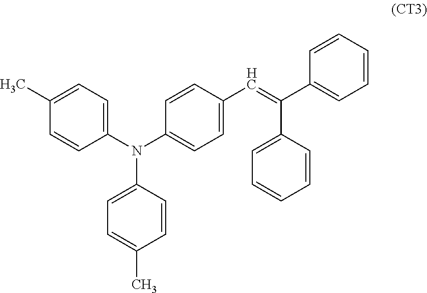 [SMILES: Cc1ccc(N(c2ccc(C)cc2)c2ccc(C=C(c3ccccc3)c3ccccc3)cc2)cc1]

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
an electroconductive substrate;
a charge generation layer that is provided on the electroconductive substrate and includes a charge generating material and a hindered phenol antioxidant; and
a charge transport layer that is provided on the charge generation layer and includes a charge transport material represented by the following formula (CT1) and a charge transport material represented by the following formula (CT2): 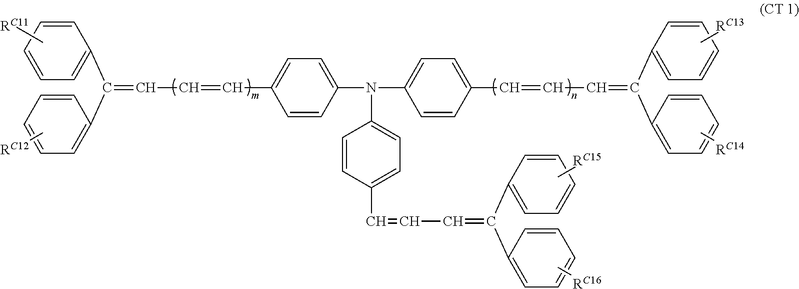
wherein R^{C11}, R^{C12}, R^{C13}, R^{C14}, R^{C15}, and R^{C16} each independently represent a hydrogen atom, a halogen atom, an alkyl group having from 1 to 20 carbon atoms, an alkoxy group having from 1 to 20 carbon atoms, or an aryl group having from 6 to 30 carbon atoms, two adjacent substituents may be bonded to each other to form a hydrocarbon ring structure, and n and m each independently represent 0, 1, or 2; and 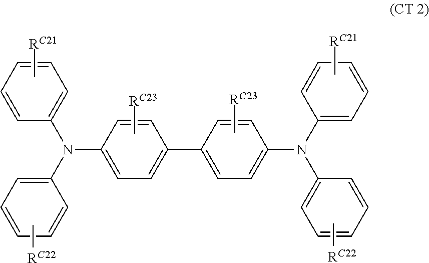
wherein R^{C21}, R^{C22}, and R^{C23} each independently represent a hydrogen atom, a halogen atom, an alkyl group having from 1 to 10 carbon atoms, an alkoxy group having from 1 to 10 carbon atoms, or an aryl group having from 6 to 10 carbon atoms.

2. The electrophotographic photoreceptor according to claim 1, wherein a molecular weight of the hindered phenol antioxidant is 300 or more.

3. The electrophotographic photoreceptor according to claim 1, wherein a molecular weight of the hindered phenol antioxidant is from 300 to 800.

4. The electrophotographic photoreceptor according to claim 1, wherein a content of the hindered phenol antioxidant is from 0.5% by weight to 10% by weight with respect to 100 parts by weight of a total amount of the charge generating material.

5. The electrophotographic photoreceptor according to claim 1, wherein a content of the hindered phenol antioxidant is from 0.5% by weight to 7% by weight with respect to 100 parts by weight of a total amount of the charge generating material.

6. The electrophotographic photoreceptor according to claim 1, wherein a content of the hindered phenol antioxidant is from 0.5% by weight to 3% by weight with respect to 100 parts by weight of a total amount of the charge generating material.

7. The electrophotographic photoreceptor according to claim 1, wherein the charge generating material is hydroxygallium phthalocyanine.

8. The electrophotographic photoreceptor according to claim 1, wherein the hindered phenol antioxidant is an antioxidant represented by the following formula (HP): 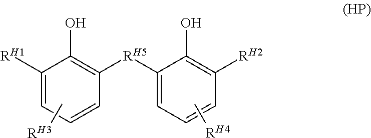
wherein R^{H1} and R^{H2} each independently represent a branched alkyl group having from 4 to 8 carbon atoms, R^{H3} and R^{H4} each independently represent a hydrogen atom or an alkyl group having from 1 to 10 carbon atoms, and R^{H5} represents an alkylene group having from 1 to 10 carbon atoms.

9. A process cartridge that comprises the electrophotographic photoreceptor according to claim 1 and is detachable from an image forming apparatus.

10. An image forming apparatus comprising:
the electrophotographic photoreceptor according to claim 1;
a charging device that charges a surface of the electrophotographic photoreceptor;
an electrostatic latent image forming device that forms an electrostatic latent image on a charged surface of the electrophotographic photoreceptor;
a developing device that accommodates a developer including a toner, and develops the electrostatic latent image formed on the surface of the electrophotographic photoreceptor by the developer to form a toner image; and
a transfer device that transfers the toner image onto a surface of a recording medium.
